(19) United States
(12) Patent Application Publication
(10) Pub. No.: US 2020/0250612 A1
(43) Pub. Date: Aug. 6, 2020

(54) SYSTEM AND METHOD FOR CLOSING CUSTOMER FEEDBACK LOOP IN DISPATCHING DELIVERY DRIVERS

(71) Applicant: Walmart Apollo, LLC, Bentonville, AR (US)

(72) Inventors: Arpan Y. Nanavati, Castro Valley, CA (US); Austin Smith, Burlingame, CA (US); Vidyanand Krishnan, Sunnyvale, CA (US); Kendy Yan Chee Lau, San Francisco, CA (US); Ridhima Kaur Arora, South San Francisco, CA (US)

(73) Assignee: Walmart Apollo, LLC, Bentonville, AR (US)

(21) Appl. No.: 16/264,159

(22) Filed: Jan. 31, 2019

(51) Int. Cl. G06Q 10/08; G06Q 30/02

(52) U.S. Cl. CPC G06Q 10/0835; G06Q 30/0282; G06Q 10/0838; G06Q 10/0834

(57) ABSTRACT

A system can comprise one or more processors; and one or more non-transitory computer-readable media storing computing instructions. In this embodiment, the computing instructions can be configured to run on the one more processors and perform a method for creating and closing a customer feedback loop, by using customer feedback to adjust future driver dispatching decisions. In this embodiment, the method can comprise dispatching a driver for a delivery of an order at a grocery store to a customer. In this embodiment, the driver can be selected from a delivery driver network of multiple delivery driver networks based on one or more driver selection factors associated with the driver and retrieved from a database; and the multiple delivery driver networks can comprise one or more on-demand delivery service providers and one or more scheduled omnichannel delivery service providers. After the delivery of the order, the method in this embodiment can receive a feedback on the delivery and the driver from the customer; automatically analyze the feedback; and automatically determine a performance of the driver for the delivery based on the feedback. In this embodiment, the method can automatically update the one or more driver selection factors associated with the driver in the database based on the performance of the driver. In this embodiment, the method can then transform the feedback into a relayed feedback based on one or more format requirements of the delivery driver network; and provide the relayed feedback to the delivery driver network. Other embodiments are disclosed.

### TECHNICAL FIELD

This disclosure relates generally to creating and closing a customer feedback loop by adjusting future driver dispatching decisions based on customer feedback.

### BACKGROUND

With the prevalence of online shopping for years, online grocery shopping is increasing, too. Some grocery stores provide online grocery shopping and deliver the purchased groceries to the customers. When the grocery stores use drivers from third-party delivery driver networks for delivering grocery orders, the grocery stores generally rely on the third-party delivery driver networks to provide quality drivers and delivery services. However, customers view the deliveries of their orders as part of the services offered by the grocery stores, not the third-party delivery drivers, so poor delivery service can hurt the reputations of the grocery stores. Therefore, systems and methods for the grocery stores to proactively ensure that strong driver performance is rewarded and poor performers are removed are desired.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a system for analyzing customer feedback on drivers delivering orders and adjusting future driver dispatching decisions accordingly, according to an embodiment;

FIG. 4 illustrates a flow chart for a method for (a) analyzing a customer feedback on a delivery of an order to a customer and also on a driver for the delivery, (b) determining the driver's performance, and (c) adjusting future driver dispatching decisions based on the driver's performance, according to another embodiment;

FIG. 5 illustrates an exemplary user interface for submitting a customer feedback on a delivery, according to another embodiment; and

FIG. 6 illustrates another exemplary user interface for submitting a customer feedback on a delivery, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

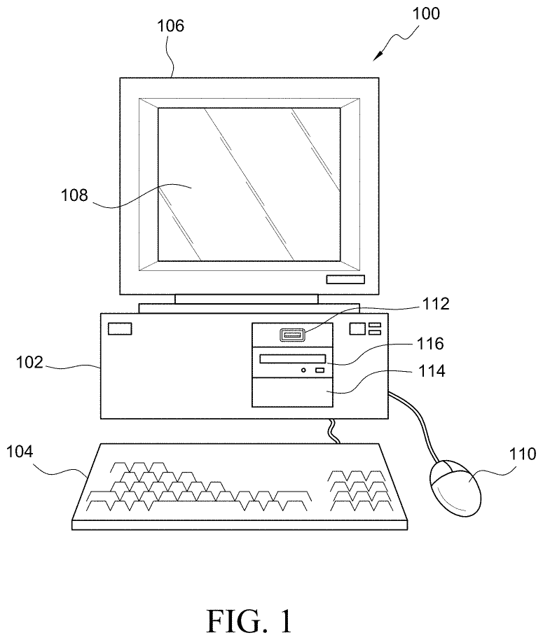

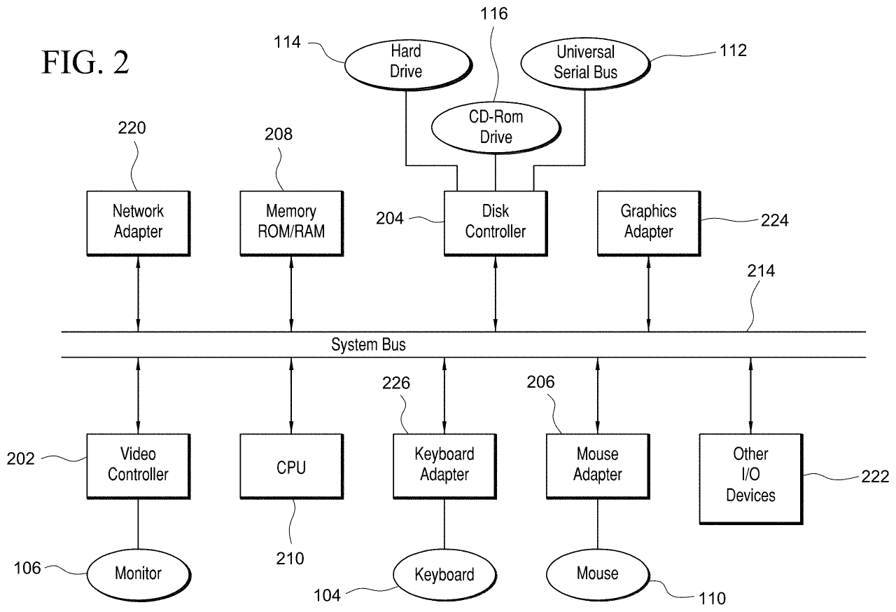

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refers to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 100) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

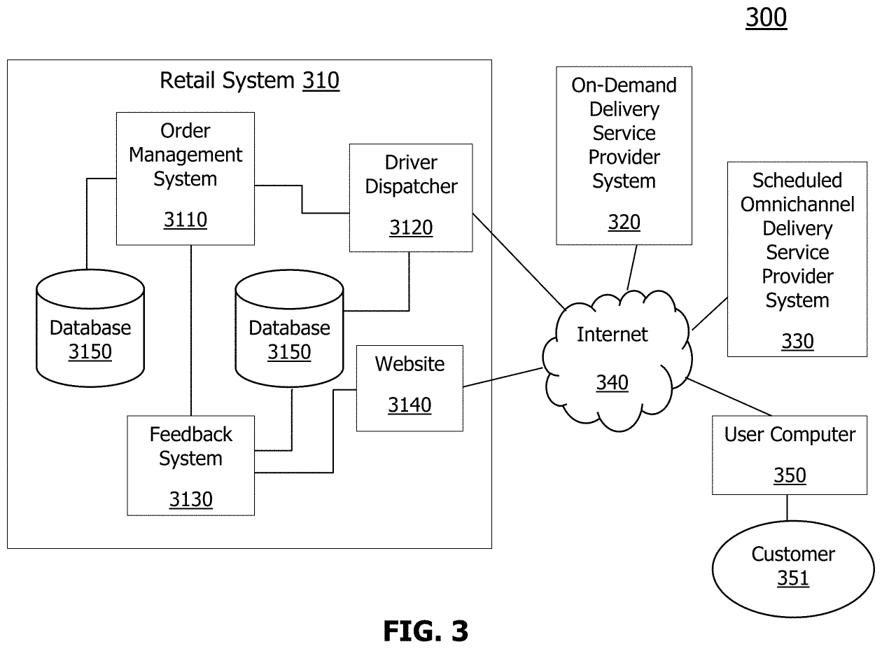

Turning ahead in the drawings, FIG. 3 illustrates a block diagram for a system 300, according to an embodiment. In many embodiments, system 300 comprises a retail system, such as system 310, one or more delivery service provider systems, such as on-demand delivery service provider system 320 and scheduled omnichannel delivery service provider system 330, a computer network, such as Internet 340, and one or more user devices, such as user computer 350. In some embodiments, retail system 310 can be configured to (a) dispatch a driver from the one or more delivery service provider systems to deliver an order to a customer, such as customer 351, (b) receive a feedback on the delivery and the driver from the customer, and (c) adjust future driver dispatching decisions based on the feedback. System 300 and retail system 310 are merely exemplary, and embodiments of system 300 and retail system 310 are not limited to the embodiments presented herein.

System 300 and retail system 310 can be employed in many different embodiments or examples not specifically depicted or described herein. In many embodiments, system 300 and retail system 310 can be adopted to dispatch a driver to deliver an order of a general retailer, such as an online retailer, a department store, or a grocery store, etc. In some embodiments, system 300 can comprise an in-house delivery driver network of the retailer and one or more third-party delivery driver networks that are independent from each other and unaffiliated with the retailer.

In some embodiments, certain elements, modules, or systems of system 300 and retail system 310 can perform various procedures, processes, and/or activities. In other embodiments, the procedures, processes, and/or activities can be performed by other suitable elements, modules, or systems of system 300 and retail system 310. System 300 and retail system 310 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 and retail system 310 described herein.

As shown in FIG. 3, retail system 310 in this embodiment can comprise an order management system, such as order management system 3110, a driver dispatcher, such as driver dispatcher 3120, a feedback system, such as feedback system 3130, a front-end system, such as website 3140, and one or more databases, such as databases 3150. In this embodiment, Internet 340 is coupled to on-demand delivery service provider system 320, scheduled omnichannel delivery service provider system 330, user computer 350, and retail system 310 at website 3140 and driver dispatcher 3120. In this embodiment, one or more databases 3150 are coupled to order management system 3110, driver dispatcher 3120, and feedback system 3130. In the same or different embodiment, order management system 3110 can be coupled to driver dispatcher 3120 and to feedback system 3130, and website 3140 also can be coupled to feedback system 3130.

In many embodiments, retail system 310 can be in data communication through Internet 340 with one or more third-party delivery service provider systems, such as on-demand delivery service provider system 320 and scheduled omnichannel delivery service provider system 330, and/or one or more user computers, such as user computer 350. In some embodiments, retail system 310 also can comprise one or more in-house delivery systems. In some embodiments, user computer 350 can be used by users, which also can be referred to as customers, such as customer 351.

In some embodiments, retail system 310 can be in data communication with user devices 340 through website 3140, and website 3140 can include one or more websites hosted by a web server that hosts one or more other websites. In many embodiments, an internal network that is not open to the public can be used for communications among order management system 3110, driver dispatcher 3120, feedback system 3130, website 3140, and databases 3150. In some embodiments where retail system 310 further comprises an in-house delivery system, the in-house delivery system can be coupled to the internal network that is not open to the public and can use the internal network to communicate with other subsystems or systems in retail system 310, including driver dispatcher 3120, etc. In these or other embodiments, an operator and/or administrator of system 310 can manage system 310, the processor(s) of system 310, and/or the memory storage unit(s) of system 310 using the input device(s) and/or display device(s) of system 310.

In many embodiments, order management system 3110 can further comprise one or more of: driver dispatcher 3120, feedback system 3130, website 3140, or one or more databases 3150. In many embodiments, driver dispatcher 3120 also can comprise feedback system 3130 and/or database 3170. Retail system 310, order management system 3110, driver dispatcher 3120, feedback system 3130, and website 3140 can each be a computer system, such as computer system 100 (FIG. 1), as described above, and can each be a single computer, a single server, or a cluster or collection of computers or servers, or a cloud of computers or servers. In other embodiments, a single computer system can host system 300 or all or part of retail system 310.

In certain embodiments, user computer 350 can be implemented with desktop computers, laptop computers, a mobile device, and/or other endpoint devices used by one or more users, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In many embodiments, system 300, retail system 310, order management system 3110, driver dispatcher 3120, feedback system 3130, and website 3140 can each include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300, retail system 310, order management system 3110, driver dispatcher 3120, feedback system 3130, and/or website 3140 in a wired manner and/or a wireless manner, and the coupling can be direct and/or indirect, as well as locally and/or remotely.

As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300, retail system 310, order management system 3110, driver dispatcher 3120, feedback system 3130, and/or website 3140. In a similar manner, the processors and/or the non-transitory computer-readable media can be local and/or remote to each other.

Meanwhile, in many embodiments, system 300, retail system 310, order management system 3110, driver dispatcher 3120, feedback system 3130, and/or web site 3140 each also can be configured to communicate with and/or include one or more databases, such as databases 3150, and/or other suitable databases. The one or more databases can include a customer order database that contains information about orders received, payment status, pickup or delivery, customer information, items associated with the orders, and so on. The one or more databases can further include a customer feedback database that contains feedback on the ordering process, the products received, the deliveries, the drivers for delivering the orders, and so on. The one or more databases also can include a payment database that contains payment method, amount, associated orders, etc. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between system 300, retail system 310, order management system 3110, driver dispatcher 3120, feedback system 3130, website 3140, databases 3150, on-demand delivery service provider system 320, scheduled omnichannel delivery service provider system 330, and/or user devices 350 can be implemented using any suitable manner of wired and/or wireless communication. Accordingly, system 300, retail system 310, order management system 3110, driver dispatcher 3120, feedback system 3130, website 3140, databases 3150, on-demand delivery service provider system 320, scheduled omnichannel delivery service provider system 330, and user devices 350 can each include any software and/or hardware components configured to implement the wired and/or wireless communication.

Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

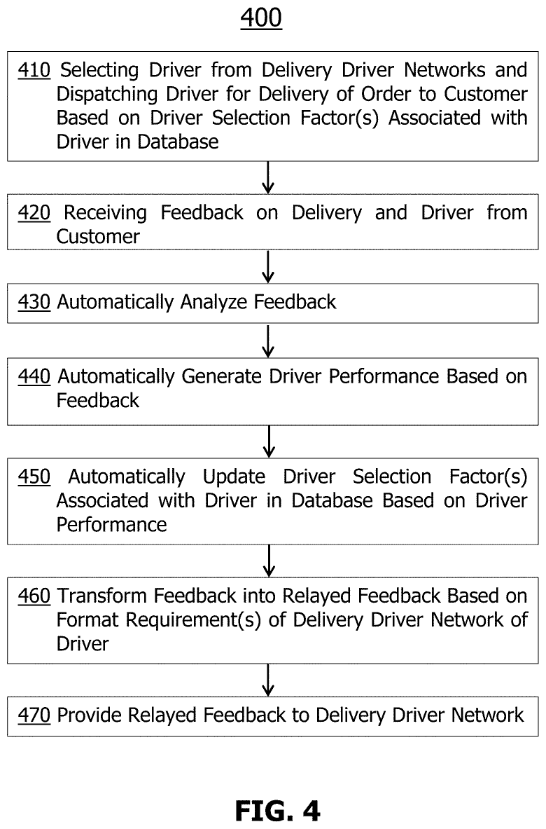

Turning ahead in the drawings, FIG. 4 illustrates a flow chart for a method 400, according to an embodiment. In many embodiments, method 400 can be implemented via execution of computing instructions configured to run at one or more processors and stored at one or more non-transitory computer-readable media, and method 400 can be configured to turn a customer feedback loop into action by adjusting one or more driver selection factors for selecting drivers from multiple delivery driver networks to deliver orders to customers. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 and/or retail system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system, such as retail system 310 (FIG. 3). The processor(s) can be similar or identical to the processor(s) described above with respect to computer system 100 (FIG. 1).

In many embodiments, method 400 can be implemented by a computer system, such as computer system 100 (FIG. 1), system 300 (FIG. 3), retail system 310 (FIG. 3), or driver dispatcher 3120 (FIG. 3), to (a) select a driver from multiple delivery driver networks, such as an in-house delivery network of retail system 310 (FIG. 3) and multiple independent third-party delivery driver networks, including on-demand delivery service provider system 320 (FIG. 3) and scheduled omnichannel delivery service provider system 330 (FIG. 3), and (b) dispatch the driver for the delivery of an order to a customer based on a driver selection factor(s) that is associated with the driver and stored in a database, such as database 3150 (FIG. 3), in block 410. Examples of the on-demand delivery service providers include the DoorDash℠ service offered by Doordash, Inc., the PostMates℠ service offered by Postmates, Inc., the Uber℠ service offered by Uber Technologies, Inc., the Deliv℠ service offered by Deliv, Inc., etc. Examples of scheduled omnichannel delivery service providers include the FedEx℠ service offered by Federal Express Corp., the UPS℠ service offered by United Parcel Service of America, Inc., and so forth. In many embodiments, method 400 can receive a confirmation from the driver that the delivery is completed, either by the driver using a user interface of a driver app to submit a delivery status update, by the customer signing at the user interface of the driver app, or by the driver calling in or texting to report the confirmation. In many embodiments, when a candidate driver of one or more candidate drivers from the multiple delivery driver networks is not associated with any driver selection factor(s) in the database, the candidate driver is new or has never been given customer reviews, so method 400 can be configured to use a default value(s) for the driver selection factor(s) for this new candidate driver to select the driver among one or more candidate drivers.

In many embodiments, after the delivery is completed, method 400 can be implemented by a computer system, such as computer system 100 (FIG. 1), system 300 (FIG. 3), retail system 310 (FIG. 3), driver dispatcher 3120 (FIG. 3), feedback system 3130 (FIG. 3), or website 3140 (FIG. 3), to receive a feedback on the delivery and the driver from the customer (block 420). In many embodiments, method 400 can provide a user interface for the customer to submit the feedback on the delivery and the driver. In many embodiments, the user interface for submitting the feedback on the delivery and the driver can be an integrated user interface that displays: (a) the order information obtained from a database, such as database 3150 (FIG. 3), and (b) the driver information obtained from the delivery driver network associated with the driver, such as on-demand delivery service provider system 320 (FIG. 3) or scheduled omnichannel delivery service provider system 330 (FIG. 3). In these and other embodiments, the integrated user interface can display the driver information in a uniform format in order to provide a consistent user experience regardless of which delivery driver network provides the driver information. In some embodiments, the user interface for customer feedback can comprise one or more of: an overall satisfaction choice; one or more predetermined responses; or a review input text box. Examples of the overall satisfaction choice can include a thumb-up-or-thumb-down combination, a number rating, or a star rating. In many embodiments, the one or more predetermined responses can comprise at least one response associated with an action or inaction of the driver, such as “driver is late” or “driver didn't come to door.”

Further, in some embodiments, the user interface for customer feedback can comprise a single-page survey with various types of inputs. In other embodiments, the user interface can comprise a survey with grouped questions in multiple pages. Additionally, in many embodiments, method 400 can solicit the feedback on the delivery and the driver from the customer by sending an email, a text message, or an in-app notification to the user computer of the customer. In many embodiments, method 400 can receive customer feedback in various forms, such as a letter, an email, a facsimile, a voice message, an online survey, a customer service survey, or a user interface configured to receive one or more user inputs to form the feedback. In some embodiments, method 400 can allow a customer to explicitly identify one or more favored or disfavored drivers in the feedback and incorporate such preference(s) in the future dispatching process in order to increase customer satisfaction of the delivery service.

After the feedback is received, in many embodiments, method 400 can be implemented by a computer system, such as computer system 100 (FIG. 1), system 300 (FIG. 3), retail system 310 (FIG. 3), driver dispatcher 3120 (FIG. 3), feedback system 3130 (FIG. 3), or website 3140 (FIG. 3), to automatically analyze the feedback (block 430) and, subsequently, to automatically generate the driver performance based on the feedback (block 440). In various embodiments, the driver performance can comprise various information, such as an overall rating and/or a list of numbers for more than one predetermined aspects of the driver performance, such as timeliness and/or attitude. In some embodiments where the feedback comprises one or more predetermined responses in a customer review survey, for example, method 400 can assign a value to each of the one or more predetermined responses. For examples, in an embodiment, method 400 can determine that when the feedback is about a late or missed delivery, the driver is at fault, and the performance of the driver can be rated based on the severity of the late or missed delivery, such as a missed delivery being rated −10, a late delivery within 5 minutes of the estimated time to arrive being rated −1, a late delivery within 10 minutes of the estimated time to arrive being rated −3, etc. In some embodiments where the feedback comprises more than predetermined responses, method 400 can analyze the feedback on the delivery and the driver by a natural language processing technique configured to identify one or more portions of the feedback that are related to the driver and determine the performance of the driver.

In many embodiments, method 400 can be implemented by a computer system, such as computer system 100 (FIG. 1), system 300 (FIG. 3), retail system 310 (FIG. 3), driver dispatcher 3120 (FIG. 3), feedback system 3130 (FIG. 3), or website 3140 (FIG. 3), to generate or update the driver selection factor(s) associated with the driver in the database, based on the driver performance (block 450). In many embodiments, method 400 also can have preferences for some delivery driver networks over other delivery driver networks based on the business relationships between the retail store and the multiple delivery driver networks and/or the overall performance of the drivers of each of the multiple delivery driver networks. In many embodiments, the driver selection factor(s) associated with a driver can comprise one or more of: (a) a rating determined based on aggregate feedback from one or more customers, including the feedback from the customer, wherein the one or more customers comprise the customer and wherein the one or more customers can comprise either all of the customers using the system and/or only those customers who are identified by the customer as someone known by, trusted by, or otherwise selected by the customer; (b) a network selection priority of the delivery driver network with which the driver is associated; (c) a preferred driver association with one or more customers, the one or more customers including the customer after the system receives preferred driver feedback from the customer, wherein the aggregate feedback comprises the preferred driver feedback; or (d) an avoided driver association with one or more customers, the one or more customers including the customer after the system receive avoided driver feedback from the customer, wherein the aggregate feedback comprise the avoided driver feedback.

In many embodiments, with customer feedback received and analyzed (blocks 420, 430, and 440) and with driver selection factors for drivers adjusted (block 450), method 400 can create and close a feedback loop in dispatching a driver for delivering an order by: selecting one or more candidate delivery driver networks from the multiple delivery driver networks based on a delivery request of the order; requesting and receiving one or more candidate drivers from the one or more candidate delivery driver networks for the delivery of the order to the customer; retrieving the one or more driver selection factors associated with each candidate driver of the one more candidate drivers; when the one or more driver selection factors associated with a candidate of the each candidate driver comprise an avoided driver association with the customer, the candidate of the each candidate driver is excluded from the one or more candidate drivers; when the one or more driver selection factors associated with a candidate of the each candidate driver comprise a preferred driver association with the customer, the driver is the candidate of the each candidate driver; and determining the driver to be dispatched based on a network selection priority and a rating of the each candidate.

In some embodiments, the delivery request can comprise one or more specific requirements, such as leaving the order at the door without signature, leaving the order with the receptionist of a business, arriving in the afternoon tomorrow, etc., and method 400 can accommodate such requirements by selecting one or more candidate delivery driver networks from the multiple delivery driver networks that can satisfy such requirements. In some embodiments, the multiple delivery driver networks can cover different geographic areas for delivery, and method 400 can decide which one or more candidate delivery driver networks of the multiple delivery driver networks to choose the driver from based on the address of the customer. In some embodiments, after the one or more candidate delivery driver networks, method 400 can request each of the one or more candidate delivery driver networks to provide one or more candidate drivers. In other embodiments, method 400 can request one or more candidate drivers from the one or more candidate delivery driver networks, one at a time, based on the preferences over the one or more candidate delivery driver networks. That is, in these or other embodiments, if the most favored candidate delivery driver network cannot provide any satisfactory candidate drivers, such as when the candidate drivers all have ratings less than 3 stars out of 5 or when the candidate drivers are all designated as avoided drivers by this customer, method 400 can request one or more candidate drivers from the next favored candidate delivery driver network, and so on.

In addition, when the driver is new or has never been dispatched by method 400, in many embodiments, method 400 can determine that the one or more driver selection factors associated with the driver do not exist in the database, and can be configured to create and save a record for the driver in the database. In many embodiments, the record for the driver can comprise information of the driver obtained from the delivery driver network associated with the driver and the one or more driver selection factors. In some embodiments, method 400 can create the record only when a first feedback on the driver is received and the driver performance is determined.

In many embodiments where the performance of the driver can affect the network selection priority of the delivery driver network that the driver is associated with, method 400 can be configured to inform the delivery driver network of the performance of the driver. In these and other embodiments where the multiple delivery driver networks are third parties of the retail store and are independent of each other, the systems of the multiple delivery driver networks (such as on-demand delivery service provider system 320 (FIG. 3) and scheduled omnichannel delivery service provider system 330 (FIG. 3)), each can have different format requirements for the performance data of the associated drivers. In many embodiments, method 400 can be implemented by a computer system, such as computer system 100 (FIG. 1), system 300 (FIG. 3), retail system 310 (FIG. 3), driver dispatcher 3120 (FIG. 3), feedback system 3130 (FIG. 3), or website 3140 (FIG. 3), to transform a customer feedback about, or performance of, a driver associated with the delivery driver network into a relayed feedback based on the format requirement(s) of the particular delivery driver network (block 460) and to provide the relayed feedback to that delivery driver network (block 470), such as on-demand delivery service provider system 320 (FIG. 3) or scheduled omnichannel delivery service provider system 330 (FIG. 3). In some embodiments, the relayed feedback also can be provided to the delivery driver by the system and/or by the driver delivery network.

In many embodiments, method 400 also can include performance of each of the multiple delivery driver networks in the feedback loop. In some embodiments, method 400 can be configured to automatically update a network performance score associated with a delivery driver network of the multiple delivery driver networks in the database based on the performance of one or more drivers associated with the delivery driver network that have been dispatched for delivery by method 400 in block 410. In some embodiments, method 400 also can automatically update the one or more driver selection factors associated with a driver associated with the delivery driver network based on the network performance score of the delivery driver network. Furthermore, in some embodiments, when the network performance score is below a predetermined network performance threshold, method 400 can be configured to exclude the delivery driver network from the multiple delivery driver networks. In some embodiments, method 400 can provide a notice and a grace or cure period for the delivery driver network to improve before excluding the delivery driver network from the multiple delivery driver networks. The exclusion of the delivery driver network from the system can be permanent or for a minimum amount of time.

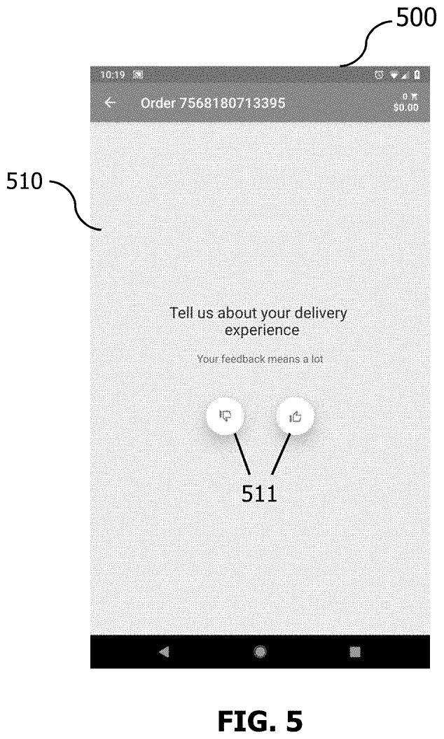

Turning ahead in the drawings, FIG. 5 illustrates a user interface 510 rendered on a display of a user computer, such as cellphone screen 500, for a user, such as customer 351 (FIG. 3), to submit a feedback on a delivery, according to another embodiment. In many embodiments, a user interface, such as user interface 510, can be adapted to various types of displays, such as screen 108 (FIG. 1) or cellphone screen 500, and configured for customers to submit feedback. In many embodiments, a user interface, such as user interface 510, for submitting customer feedback can comprise various types of input formats, including overall satisfaction choice 511, such as a thumb-up-or-thumb-down choice, a like-or-dislike choice, a number rating, or a star rating.

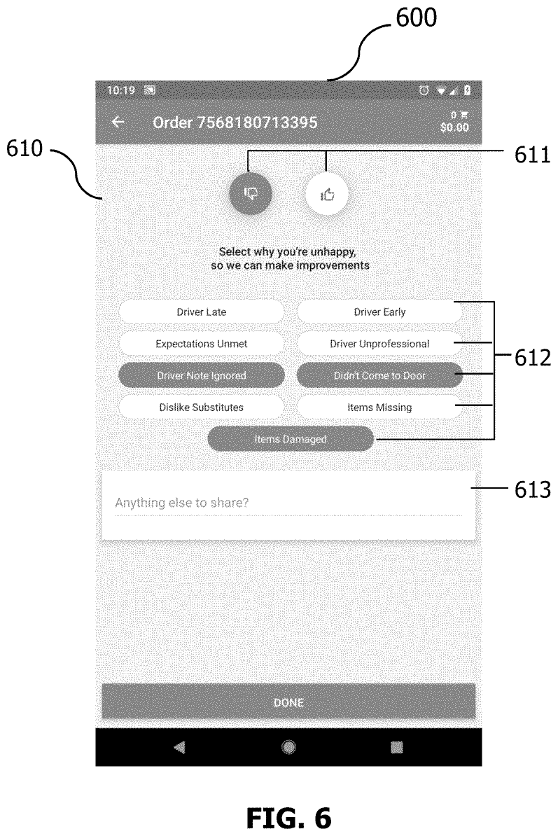

Turning ahead in the drawings, FIG. 6 illustrates a user interface 610 rendered on a display of a user computer, such as cellphone screen 600, for a user, such as customer 351 (FIG. 3), to submit a review on a delivery and a driver, according to another embodiment. In this embodiment, user interface 610 can comprise overall satisfaction choice 611, one or more predetermined responses 612, and review input text box 613. In this embodiment, overall satisfaction choice 611 can comprise one of a thumb-up-or-thumb-down choice, a like-or-dislike choice, a number rating, or a star rating. In this embodiment, one or more predetermined responses 612 are determined based on the overall satisfaction choice 611, and at least one of the one or more predetermined responses 612 is about the action or inaction of the delivery driver. Review input text box 613 in this embodiment can be used to submit a text, with limited or unlimited character numbers.

User interfaces 510 and 610 in FIGS. 5-6 are merely exemplary and are not limited to the embodiments presented herein. User interfaces 510 and 610 can be employed in many different embodiments or examples not specifically depicted or described herein. In many embodiments, user interface 510 and user interface 610 can be rendered in a sequence. For example, in an embodiment, after a customer chooses an order to review, user interface 510 (FIG. 5) is rendered on the user computer of the customer to allow the customer to submit overall satisfaction choice 511 (FIG. 5). In this embodiment, after the overall satisfaction choice 511 (FIG. 5) is submitted, such as a thumb-down of overall satisfaction choice 511 (FIG. 5), the user interface can be updated to render user interface 610 or a portion of user interface 610 with review input text box 613 (FIG. 3) and one or more predetermined responses 612 (FIG. 6) determined based on the overall satisfaction choice 611 (FIG. 6). In other embodiments, the designs, the elements, and/or arrangements of the elements can be replaced by other suitable designs, elements, and/or arrangements of the elements of user interfaces 510 (FIG. 5) and 610 (FIG. 6). In many embodiments, retail system 310 (FIG. 3), website 3140 (FIG. 3), and/or method 400 (FIG. 4) can be suitable to adopt user interface 510 (FIG. 5), user interface 610 (FIG. 6), and/or one or more of the designs, elements, or arrangements of the elements of user interfaces 510 (FIG. 5) and/or 610 (FIG. 6).

In an embodiment, a system can comprise one or more processors; and one or more non-transitory computer-readable media storing computing instructions. In this embodiment, the computing instructions can be configured to run on the one more processors and perform a method for creating and closing a customer feedback loop, by using customer feedback to adjust future driver dispatching decisions. In this embodiment, the method can comprise dispatching a driver for a delivery of an order at a grocery store to a customer. In this embodiment, the driver can be selected from a delivery driver network of multiple delivery driver networks based on one or more driver selection factors associated with the driver and retrieved from a database; and the multiple delivery driver networks can comprise one or more on-demand delivery service providers and one or more scheduled omnichannel delivery service providers.

In this embodiment, after the delivery of the order, the method can receive a feedback on the delivery and the driver from the customer; automatically analyze the feedback; and automatically determine a performance of the driver for the delivery based on the feedback. In this embodiment, the method can automatically update the one or more driver selection factors associated with the driver in the database based on the performance of the driver. In this embodiment, the method can then transform the feedback into a relayed feedback based on one or more format requirements of the delivery driver network; and provide the relayed feedback to the delivery driver network.

In another embodiment, a method can be implemented via execution of computing instructions configured to run at one or more processors and stored at one or more non-transitory computer-readable media. In this embodiment, the method can comprise: dispatching a driver for a delivery of an order at a grocery store to a customer, wherein: the driver is selected from a delivery driver network of multiple delivery driver networks based on one or more driver selection factors associated with the driver and retrieved from a database; and the multiple delivery driver networks comprise one or more on-demand delivery service providers and one or more scheduled omnichannel delivery service providers.

After the delivery of the order, the method in this embodiment can further comprise: receiving a feedback on the delivery and the driver from the customer; automatically analyzing the feedback; determining a performance of the driver for the delivery based on the feedback; and automatically updating the one or more driver selection factors associated with the driver in the database based on the performance of the driver. In this embodiment, the method also can transform the feedback into a relayed feedback based on one or more format requirements of the delivery driver network; and provide the relayed feedback to the delivery driver network.

In many embodiments, the techniques described herein can provide a practical application and several technological improvements. In many embodiments, the system or the method for creating and closing a customer feedback loop in delivery driver dispatching comprise specific technological advantages because they adopt a database(s) that comprise only records of the delivery drivers that were dispatched and reviewed by customers, rather than all the drivers that were dispatched and/or rather than all of the available drivers, in order to reduce the size of the database(s). In a number of embodiments, the techniques described herein can advantageously provide a consistent user experience by providing an integrated user interfaces for a customer to provide feedback on the delivery of an order and the driver regardless of which delivery driver network was used to deliver the order.

In many embodiments, the techniques described herein can be used continuously at a scale that cannot be handled using manual techniques. For example, the number of drivers in the system can exceed many thousands.

In a number of embodiments, the techniques described herein can solve a technical problem that arises only within the realm of computer networks, as online grocery orders and their deliveries do not exist outside the realm of computer networks. Moreover, the techniques described herein can solve a technical problem that cannot be solved outside the context of computer networks. Specifically, the techniques described herein cannot be used outside the context of computer networks, in view of the enormous amount of feedback and other data that must be received, transmitted, organized, updated, and managed.

Although systems and methods for closing a customer feedback loop in dispatching drivers for delivery have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities in the blocks of FIG. 4 may include different procedures, processes, activities, and/or blocks and may be performed by many different components in many different orders. As yet another example, the grocery store and order can be replaced by a general retail store and a general retail order.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one more processors and perform:
dispatching a driver for a delivery of an order at a grocery store to a customer, wherein:
the driver is selected from a delivery driver network of multiple delivery driver networks based on one or more driver selection factors associated with the driver and retrieved from a database; and
the multiple delivery driver networks comprise one or more on-demand delivery service providers and one or more scheduled omnichannel delivery service providers;
after the delivery of the order, receiving a feedback on the delivery and the driver from the customer;
automatically analyzing the feedback;
automatically determining a performance of the driver for the delivery based on the feedback;
automatically updating the one or more driver selection factors associated with the driver in the database based on the performance of the driver;
transforming the feedback into a relayed feedback based on one or more format requirements of the delivery driver network; and
providing the relayed feedback to the delivery driver network.

2. The system of claim 1, wherein the computing instructions are further configured to run on the one more processors and perform:
automatically updating a network performance score associated with the delivery driver network in the database based on the performance of the driver;
automatically updating the one or more driver selection factors associated with the driver based on the network performance score; and
when the network performance score is below a predetermined network performance threshold, excluding the delivery driver network from the multiple delivery driver networks.

3. The system of claim 1, wherein the one or more driver selection factors associated with the driver comprise one or more of:
a rating determined based on aggregate feedback from one or more customers, the aggregate feedback including the feedback from the customer, wherein the one or more customers comprise the customer;
a network selection priority of the delivery driver network;
a preferred driver association with one or more customers, the one or more customers including the customer after the system receives preferred driver feedback from the customer, wherein the aggregate feedback comprise the preferred driver feedback; or
an avoided driver association with one or more customers, the one or more customers including the customer after the system receive avoided driver feedback from the customer, wherein the aggregate feedback comprise the avoided driver feedback.

4. The system of claim 3, wherein the dispatching the driver further comprises:
selecting one or more candidate delivery driver networks from the multiple delivery driver networks based on a delivery request of the order;
requesting and receiving one or more candidate drivers from the one or more candidate delivery driver networks for the delivery of the order to the customer;
retrieving the one or more driver selection factors associated with each candidate driver of the one more candidate drivers;
when the one or more driver selection factors associated with a candidate of the each candidate driver comprise an avoided driver association with the customer, the candidate of the each candidate driver is excluded from the one or more candidate drivers;
when the one or more driver selection factors associated with a candidate of the each candidate driver comprise a preferred driver association with the customer, the driver is the candidate of the each candidate driver; and
determining the driver to be dispatched based on a network selection priority and a rating of the each candidate.

5. The system of claim 1 further comprising a user interface configured to be rendered on a user computer of the customer and configured to submit the feedback on the delivery and the driver from the customer, the user interface comprising one or more of:
one or more predetermined responses, at least one of the one or more predetermined responses being associated with an action of the driver; or
a review input text box.

6. The system of claim 5, wherein:
the user interface further comprises an overall satisfaction choice; and
after the overall satisfaction choice is received from the customer, the user interface is configured to render (a) the one or more of the one or more predetermined responses and (b) the review input text box.

7. The system of claim 6, wherein the one or more predetermined responses are determined according to the overall satisfaction choice received from the customer.

8. The system of claim 1, wherein the feedback from the customer is received from one of: a customer service survey or a user interface configured to receive one or more user inputs to form the feedback.

9. The system of claim 1, wherein the computing instructions are further configured to run on the one more processors and perform:
sending a request for the feedback to a user computer of the customer after the delivery is completed and before the feedback is received.

10. The system of claim 1, wherein the computing instructions are further configured to run on the one more processors and perform:
after the performance of the driver is determined, when the one or more driver selection factors associated with the driver do not exist in the database, creating and saving a record for the driver in the database, the record comprising information of the driver obtained from the delivery driver network and the one or more driver selection factors.

11. A method being implemented via execution of computing instructions configured to run at one or more processors and stored at one or more non-transitory computer-readable media, the method comprising:
dispatching a driver for a delivery of an order at a grocery store to a customer, wherein:
the driver is selected from a delivery driver network of multiple delivery driver networks based on one or more driver selection factors associated with the driver and retrieved from a database; and
the multiple delivery driver networks comprise one or more on-demand delivery service providers and one or more scheduled omnichannel delivery service providers;
after the delivery of the order, receiving a feedback on the delivery and the driver from the customer;
automatically analyzing the feedback;
determining a performance of the driver for the delivery based on the feedback;
automatically updating the one or more driver selection factors associated with the driver in the database based on the performance of the driver;
transforming the feedback into a relayed feedback based on one or more format requirements of the delivery driver network; and
providing the relayed feedback to the delivery driver network.

12. The method of claim 11 further comprising:
automatically updating a network performance score associated with the delivery driver network in the database based on the performance of the driver;
automatically updating the one or more driver selection factors associated with the driver based on the network performance score; and
when the network performance score is below a predetermined network performance threshold, excluding the delivery driver network from the multiple delivery driver networks.

13. The method of claim 11, wherein the one or more driver selection factors associated with the driver comprise one or more of:
a rating determined based on aggregate feedback from one or more customers, the aggregate feedback including the feedback from the customer, wherein the one or more customers comprise the customer;
a network selection priority of the delivery driver network;
a preferred driver association with one or more customers, the one or more customers including the customer after the system receives preferred driver feedback from the customer, wherein the aggregate feedback comprise the preferred driver feedback; or
an avoided driver association with one or more customers, the one or more customers including the customer after the system receive avoided driver feedback from the customer, wherein the aggregate feedback comprise the avoided driver feedback.

14. The method of claim 13, wherein the dispatching the driver further comprises:
selecting one or more candidate delivery driver networks from the multiple delivery driver networks based on a delivery request of the order;
requesting and receiving one or more candidate drivers from the one or more candidate delivery driver networks for the delivery of the order to the customer;
retrieving the one or more driver selection factors associated with each candidate driver of the one more candidate drivers;
when the one or more driver selection factors associated with a candidate of the each candidate driver comprise an avoided driver association with the customer, the candidate of the each candidate driver is excluded from the one or more candidate drivers;
when the one or more driver selection factors associated with a candidate of the each candidate driver comprise a preferred driver association with the customer, the driver is the candidate of the each candidate; and
determining the driver to be dispatched based on a network selection priority and a rating of the each candidate.

15. The method of claim 11 further comprising:
providing a user interface configured to be rendered on a user computer of the customer and configured to submit the feedback on the delivery and the driver from the customer, the user interface comprising one or more of:
one or more predetermined responses, at least one of the one or more predetermined responses being associated with an action of the driver; or
a review input text box.

16. The method of claim 15, wherein:
the user interface further comprises an overall satisfaction choice; and
after the overall satisfaction choice is received from the customer, the user interface is configured to render (a) the one or more of the one or more predetermined responses and (b) the review input text box.

17. The method of claim 16, wherein the one or more predetermined responses are determined according to the overall satisfaction choice received from the customer.

18. The method of claim 11, wherein the feedback from the customer is received from one of: a customer service survey or a user interface configured to receive one or more user inputs to form the feedback.

19. The method of claim 11 further comprising:
sending a request for the feedback to a user computer of the customer after the delivery is completed and before the feedback is received.

20. The method of claim 11 further comprising:
after the performance of the driver is determined, when the one or more driver selection factors associated with the driver do not exist in the database, creating and saving a record for the driver in the database, the record comprising information of the driver obtained from the delivery driver network and the one or more driver selection factors.
